(19) United States
(12) Patent Application Publication
(10) Pub. No.: US 2016/0171863 A1
(43) Pub. Date: Jun. 16, 2016

(54) Medical Information and Tracking System

(71) Applicant: Sheldine Murrell, Jamaica, NY (US)

(72) Inventor: Sheldine Murrell, Jamaica, NY (US)

(21) Appl. No.: 14/966,739

(22) Filed: Dec. 11, 2015

Related U.S. Application Data
(60) Provisional application No. 62/090,713, filed on Dec. 11, 2014.

(51) Int. Cl. G08B 21/02

(52) U.S. Cl. CPC G08B 21/0269

(57) ABSTRACT

A medical information and tracking system is provided. The system includes a wearable piece of tracking jewelry having a housing and a tracking unit. Both the tracking unit and the tracking jewelry include speakers, each of which sound an audible alarm if the tracking jewelry moves a threshold distance from the tracking unit. The tracking jewelry also includes a GPS that determines the geographic location of the tracking jewelry, which is wirelessly communicated to the tracking unit over a network. Further, the jewelry also contains a computer readable medium for storing medical information of the wearer, which is accessible via a port by approved medical personnel.

### CROSS REFERENCE TO RELATED APPLICATIONS

This application claims the benefit of U.S. Provisional Application No. 62/089,896 filed on Dec. 10, 2014. The above identified patent application is herein incorporated by reference in its entirety to provide continuity of disclosure.

### BACKGROUND OF THE INVENTION

The present invention relates to medical information systems. More specifically, the present invention relates to medical information systems having a wearable tracking device having a proximity alarm that sounds when the device is moved a threshold distance from a tracking unit.

Many individuals such as children, elderly, and physically or mentally impaired persons require constant monitoring for safety purposes. If such an individual wanders away from a guardian and becomes lost or incapacitated, it may be incredibly difficult for the guardian to locate the individual. Also, many of these same individuals may have difficulty returning to the guardian on their own. There is therefore a need for a tracking system having a wearable component for an individual that alerts a guardian if an individual travels a specific distance from the guardian, and provides the location of the individual to the guardian so that the individual may be quickly found and recovered.

For some of the aforementioned individuals, communication with others, particularly strangers, can be difficult. Also, in the event of an emergency or other event, an individual may become incapacitated for a period of time. In the either case, the individual may be unable to communicate to medical staff or other emergency responders important information such as the individual's identity, home address, or the nature of the present emergency. Further, the individual may be unable to provide their personal medical information such as primary doctor information, release forms, consent forms, blood type, medical history, medication information, allergies, etc. to the appropriate medical personnel, which may delay treatment for the individual and increase the risk of additional harm. Therefore, there is need for a wearable tracking device that also stores the medical information of the wearer and provides access to said medical information to medical professionals.

### SUMMARY OF THE INVENTION

In view of the foregoing disadvantages inherent in the known types of medical information systems now present in the prior art, the present invention provides a medical information and tracking system wherein the same can be utilized for providing convenience for the user when determining the location of a lost information or providing medical information to a medical professional. The present system comprises a wearable tracking jewelry that communicates with a tracking unit in order to provide the location of the wearer.

One object of the present invention is to provide wearable tracking jewelry having the medical information of the wearer stored thereon.

Another object of the present invention is to provide a tracking system that provides for an alarm to be sounded by wearable tracking jewelry that alerts nearby individuals to the wearer's presence and current situation.

Still a further object of the present invention is to provide tracking unit comprising a power source in operable and electrical communication with a speaker, a first proximity sensor, and a wireless receiver, a tracking jewelry comprising a power source in operable and electrical communication with a GPS, a second proximity sensor configured to monitor the distance between the it and the first proximity sensor, a speaker, a wireless transceiver, and a processor; a non-transitory computer readable medium having medical information of a wearer of the tracking jewelry stored thereon operatively connected to the processor; and a logic stored in the non-transitory computer readable medium that, when executed by the processor, causes the medical jewelry and tracking system to perform a method, the method comprising the steps of: if the tracking jewelry is a threshold distance from the tracking unit, then the tracking unit sounding an alarm via the speaker, and transmitting information comprising the geographic location of the tracking jewelry to the tracking unit.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the tracking jewelry component of a medical information and tracking system according to the present invention.

FIG. 2 shows a schematic view of a medical information and tracking system according to the present invention.

### DETAILED DESCRIPTION OF THE INVENTION

Reference is made herein to the attached drawings. Like reference numerals are used throughout the drawings to depict like or similar elements of the XXX. For the purposes of presenting a brief and clear description of the present invention, the preferred embodiment will be discussed as used for medical information and tracking systems. The figures are intended for representative purposes only and should not be considered to be limiting in any respect.

As used herein, “logic” refers to (i) logic implemented as computer instructions and/or data within one or more computer processes and/or (ii) logic implemented in electronic circuitry.

As used herein, “computer-readable medium” excludes any transitory signals, but includes any non-transitory data storage circuitry, e.g., buffers, cache, and queues, within transceivers of transitory signals.

According to some embodiments, the operations, techniques, and/or components described herein can be implemented by an electronic device, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that incorporates hard-wired and/or program logic to implement the techniques and other features of the present disclosure.

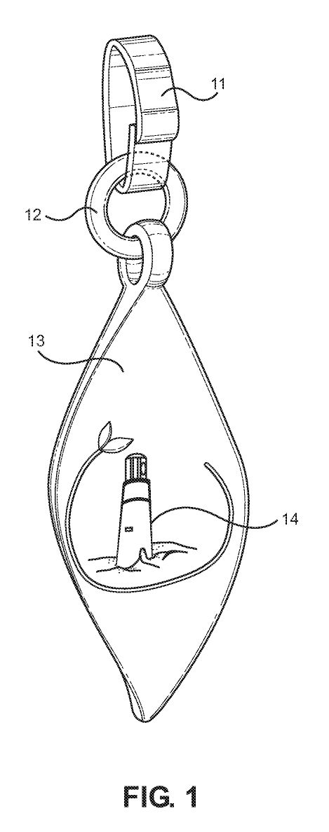

Referring now to FIG. 1, there is shown a perspective view of the tracking jewelry component of the medical information jewelry and tracking system. The tracking jewelry comprises a housing 13 having various electronic components disposed therein. The housing 13 is connected to a support 12, which in turn is connected to a clasp 11. The clasp 11 comprises a closable loop of material and is utilized to secure the housing 13 to a wearer. The clasp 11 may secure the housing 13 to a wearer's clothing, or may be configured to attach to a wearer's existing piercing sites such as an ear piercing. The clasp 11 may further be configured to secure the housing 13 to an existing piece of jewelry such as a necklace or bracelet.

Indicia 14 may be displayed on an outer surface of the tracking jewelry. In one embodiment of the invention, the indicia 14 comprises an image of a lighthouse in order to provide assurances of safety to the wearer, because a lighthouse represents a symbol of a beacon of hope used to ensure voyagers a safe passage home. The indicia 14 may further comprise a particular serial number that is unique to that particular user's system in order to provide for identification of the wearer.

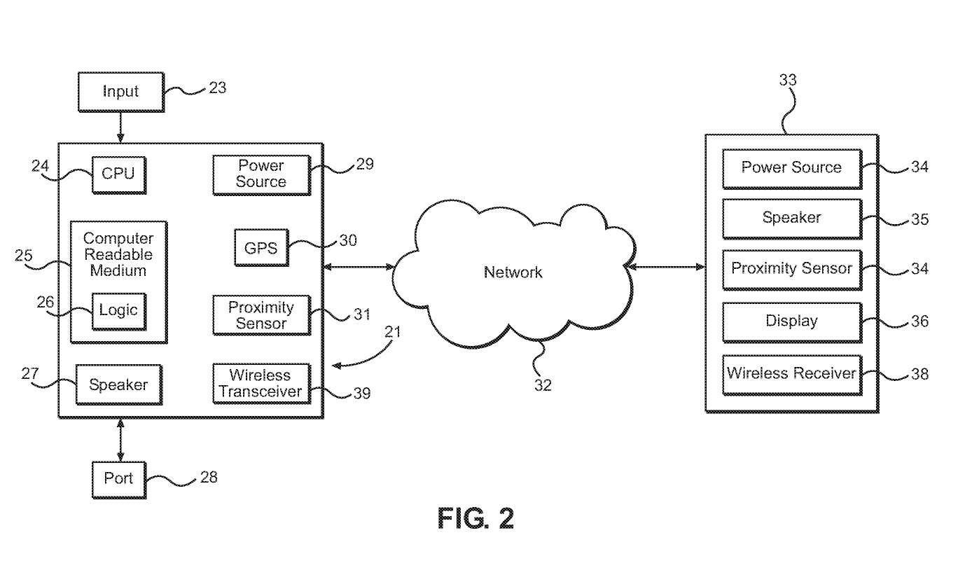

Referring now to FIG. 2, there is shown a schematic view of a medical information jewelry and tracking system according to the present invention. The medical information jewelry and tracking system comprises tracking jewelry 21 and a tracking unit 33. The tracking jewelry 21 comprises a power source 29, which may be a rechargeable battery. The power source 29 is in operable and electrical communication with a computer processing unit (CPU) 24, a computer readable medium 25, a speaker 27, a GPS 30, a wireless transceiver 39, and a proximity sensor 31. The computer readable medium 25 may be a storage such as a memory. A logic 26 is stored on the computer readable medium 25. When executed by the CPU 24, the logic 26 causes the jewelry 21 to perform a method. The proximity sensor is configured to monitor the distance between the tracking jewelry 21 and the tracking unit 33.

The tracking unit 33 comprises a housing having a power source 34 disposed therein, wherein the power source 34 may be a connection to an AC outlet, a battery, or other similar means of supplying power to the unit. The power source 34 is in electrical and operable communication with a speaker 35, a proximity sensor 34, a display 36, and a wireless receiver 38. The proximity sensor 34 is configured to monitor the distance between the tracking unit 33 and the tracking jewelry 21.

The GPS 30 is configured to determine the geographic location of the tracking jewelry 21. When the tracking jewelry 21 is a threshold distance from the tracking unit 33 as determined by the proximity sensors 31, 34, the logic 26 causes the tracking jewelry 21 to transmit the geographic location of the tracking jewelry 21 to the tracking unit 33. The geographic location of the tracking jewelry 21 is transferred wirelessly via the wireless transceiver 39 over a network 32 to the tracking unit 33. The network 32 may be a Wi-Fi network, cellular network, or similar. In some embodiments of the invention, the geographic information received by the tracking unit 33 may be displayed on the display 36 in the form of a map display or as geographic coordinates.

The logic 26 also causes an audible alarm to be emitted from the speakers 27, 34 when the tracking jewelry 21 is a threshold distance from the tracking unit 33. The alarm emitted by the speaker 27 of the tracking jewelry 21 may include messages such as “help me” in order to alert nearby individuals that the wearer needs assistance. The alarm emitted by the speaker 34 of the tracking unit 33 may emit a similar message; however, the particular sound or message emitted by each of the speakers 27, 34 may vary according to user preference. The particular sound for the alarm may be stored on the computer readable medium 25.

Medical information of the user is stored on the computer readable medium 25 of the tracking jewelry 21 and is entered thereto via an input 23 such as a keyboard, touchpad, or data transfer from another device. The medical information stored on the computer readable medium 25 may include, but is not limited to, medical records, prescription information, home address, guardian or family contact information, doctor information, allergy information, or other information. The medical information may be altered by the user at any time should information need to be added, changed, or removed.

The tracking jewelry 21 further comprises a port 28 that provides access to the medical information stored on the computer readable medium 25. The port 28 may be a USB port, wireless access port provided via communication with a website, or other communications port that provides for the transfer of information from the tracking jewelry 21 to a third party computing device such as a tablet, cellphone, laptop, PC, or similar. In one embodiment of the invention, the tracking jewelry 21 requires the input of a secure password only known by the appropriate medical and emergency personnel before providing the medical information stored thereon, so that the medical information of the wearer is not accessed by an unwanted individual.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A medical jewelry and tracking system comprising:
A tracking unit comprising a power source in operable and electrical communication with a speaker, a first proximity sensor, and a wireless receiver;
A tracking jewelry comprising a power source in operable and electrical communication with a GPS, a second proximity sensor configured to monitor the distance between the it and the first proximity sensor, a speaker, a wireless transceiver, and a processor;
a non-transitory computer readable medium having medical information of a wearer of the tracking jewelry stored thereon operatively connected to the processor;
a logic stored in the non-transitory computer readable medium that, when executed by the processor, causes the medical jewelry and tracking system to perform a method, the method comprising the steps of:
if the tracking jewelry is a threshold distance from the tracking unit, then the tracking unit sounding an alarm via the speaker, and
transmitting information comprising the geographic location of the tracking jewelry to the tracking unit.

2) The medical jewelry and tracking system of claim 1, wherein the method further comprises the step of displaying the geographic location information of the tracking jewelry on a display of the tracking unit, wherein the display is in operable communication with the power source of the tracking unit.

3) The medical jewelry and tracking system of claim 1, wherein the tracking jewelry further comprises a port, wherein the port provides access to the medical information stored on the computer readable medium of the tracking jewelry.

4) The medical jewelry and tracking system of claim 3, wherein the port is a USB port.

5) The medical jewelry and tracking system of claim 3, wherein the port is a wireless communications port.

6) The medical jewelry and tracking system of claim 3, wherein the computer readable medium further comprises an access password stored thereon, and wherein the port provides access to the medical information stored on the computer readable medium upon receiving an input comprising at least the access password.

7) The medical jewelry and tracking system of claim 6, wherein the tracking jewelry comprises indicia disposed on an outer surface thereof.

8) The medical jewelry of claim 7, wherein the indicia comprises the image of a lighthouse.

9) The medical jewelry of claim 8, wherein the medical information stored on the computer readable medium comprises at least one of a wearer's home address, guardian contact information, medical records, primary doctor contact information, medication information, or allergy information.
